(19) United States
(12) Patent Application Publication
(10) Pub. No.: US 2026/0128222 A1
(43) Pub. Date: May 7, 2026

(54) MULTILAYER ELECTRONIC COMPONENT

(71) Applicant: SAMSUNG ELECTRO-MECHANICS CO., LTD., Suwon-si (KR)

(72) Inventors: Dae Jin SHIM, Suwon-si (KR); Jae Won KIM, Suwon-si (KR); Jung Jin PARK, Suwon-si (KR); Jung Jin PARK, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/261,016

(22) Filed: Jul. 7, 2025

(30) Foreign Application Priority Data
Nov. 1, 2024 (KR) 10-2024-0153643

(51) Int. Cl. H01G 4/224; H01G 4/008; H01G 4/12; H01G 4/232; H01G 4/248; H01G 4/30

(52) U.S. Cl. CPC H01G 4/224; H01G 4/008; H01G 4/12; H01G 4/232; H01G 4/248; H01G 4/30

(57) ABSTRACT

A multilayer electronic component includes a body including a capacitance forming portion including a dielectric layer and an internal electrode alternately disposed with the dielectric layer in a first direction, and a cover portion disposed on both end surfaces of the capacitance forming portion in the first direction; and an external electrode disposed on the body, wherein the cover portion includes titanium (Ti), gallium (Ga) and magnesium (Mg), and when the number of moles of gallium (Ga) relative to 100 moles of titanium (Ti) of the cover portion is CG and the number of moles of magnesium (Mg) relative to 100 moles of titanium (Ti) of the cover portion is CM, 0.2≤CG/CM<1.0 is satisfied.

### CROSS-REFERENCE TO RELATED APPLICATION(S)

This application claims benefit of priority to Korean Patent Application No. 10-2024-0153643 filed on Nov. 1, 2024, the disclosure of which is incorporated herein by reference in their entireties.

### TECHNICAL FIELD

The present disclosure relates to a multilayer electronic component.

A multilayer ceramic capacitor (MLCC), one of multilayer electronic components, may be a chip-type condenser mounted on printed circuit boards of various electronic products, such as an imaging device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices. There has been increasing demand for a multilayer ceramic capacitor to have a reduced size and higher capacitance as each of various electronic devices such as a computer and a mobile device have a reduced size and higher output.

As miniaturization and high capacitance progresses, the need to protect a region for forming capacitance is increasing, which is being improved by adding a margin region surrounding the region for forming capacitance. However, as a structural design is continuously changed to achieve miniaturization and high capacitance, as the size of the region for forming capacitance increases and the size of the margin region protecting the region for forming capacitance decreases, there may be a concern that moisture resistance reliability and strength of the multilayer ceramic capacitor may be decreased.

To improve the problems described above, a grain size of a cover portion may be designed to be small and uniform, but when the grain size is reduced, breakdown voltage characteristics may be improved, but there may be a problem in that a side effect of reduced reliability may be caused by an increase in pores due to reduced density.

### SUMMARY

An aspect of the present disclosure is to provide a multilayer electronic component having improved moisture resistance reliability by improving density of a cover portion to suppress the formation of pores.

An aspect of the present disclosure is to provide a multilayer electronic component having improved breakdown voltage characteristics.

However, various problems to be solved by the present disclosure are not limited to the above-described contents, and can be more easily understood in the process of explaining specific embodiments of the present disclosure.

According to an aspect of the present disclosure, a multilayer electronic component may include a body including a capacitance forming portion including a dielectric layer and an internal electrode alternately disposed with the dielectric layer in a first direction, and a cover portion disposed on both end surfaces of the capacitance forming portion in the first direction; and an external electrode disposed on the body, wherein the cover portion may include titanium (Ti), gallium (Ga) and magnesium (Mg), and when a number of moles of gallium (Ga) relative to 100 moles of titanium (Ti) of the cover portion is CG and a number of moles of magnesium (Mg) relative to 100 moles of titanium (Ti) of the cover portion is CM, 0.2≤CG/CM<1.0 may be satisfied.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure;

FIG. 2 schematically illustrates an exploded perspective view illustrating a stack structure of internal electrodes;

FIG. 3 schematically illustrates a cross-sectional view of FIG. 1, taken along line I-I′;

FIG. 4 schematically illustrates a cross-sectional view of FIG. 1, taken along line II-II′;

FIG. 5 schematically illustrates a cross-sectional view of FIG. 1, taken along line II-II′ according to another embodiment of the present disclosure;

FIG. 6A is an image of a cross-section of a cover portion taken using a transmission electron microscope (TEM), FIG. 6B is an image of the same cross-section of a cover portion obtained by mapping magnesium (Mg) in a TEM-EDS mode, and FIG. 6C is an image of the same cross-section of a cover portion obtained by mapping gallium (Ga) in a TEM-EDS mode;

FIG. 7A is an image of pores observed in a cross-section of a cover portion of Comparative Example, and FIG. 7B is an image of pores observed in a cross-section of a cover portion of Example;

FIG. 8A is a graph illustrating the number of pores (ea) observed in cross-sections of cover portions of Comparative Example and Example, and FIG. 8B is a graph illustrating porosity (%) observed in cross-sections of cover portions of Comparative Example and Example;

FIG. 9A is an image of a cross-section of a cover portion before sintering of Comparative Example, taken using a transmission electron microscope (TEM), and FIG. 9B is an image of a cross-section of a cover portion before sintering of Example, taken using a transmission electron microscope (TEM);

FIG. 10A is an image of a cross-section of a cover portion and a capacitance forming portion of Comparative Example, taken using a transmission electron microscope (TEM), and FIG. 10B is an image of a cross-section of a cover portion and a capacitance forming portion of Example, taken using a transmission electron microscope (TEM);

FIG. 11A is a graph for evaluating moisture resistance reliability of Comparative Example, and FIG. 11B is a graph for evaluating moisture resistance reliability of Example; and

FIG. 12A is an image of a cross-section of a cover portion of Comparative Example, taken using a transmission electron microscope (TEM) and the observed dielectric grains were distinguished using a program, and FIG. 12B is an image of a cross-section of a cover portion of Example, taken using a transmission electron microscope (TEM) and the observed dielectric grains were distinguished using a program.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a first direction may be defined as a stacking direction or a thickness (T) direction, a second direction may be defined as a length (L) direction, and a third direction may be defined as to a width (W) direction.

### Multilayer Electronic Component

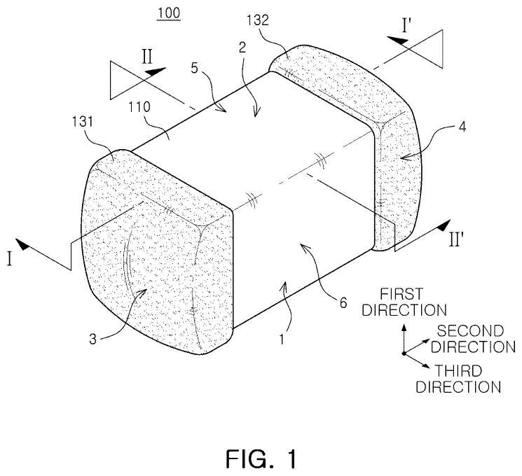

FIG. 1 schematically illustrates a perspective view of a multilayer electronic component according to an embodiment of the present disclosure.

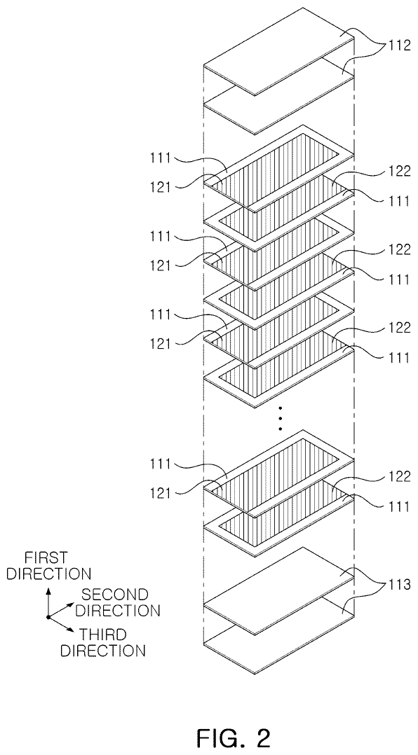

FIG. 2 schematically illustrates an exploded perspective view illustrating a stack structure of internal electrodes.

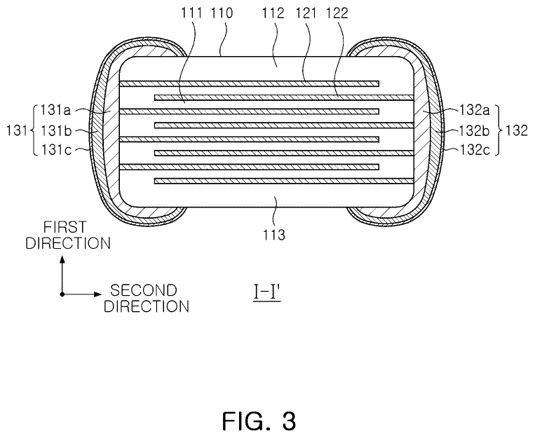

FIG. 3 schematically illustrates a cross-sectional view of FIG. 1, taken along line I-I′.

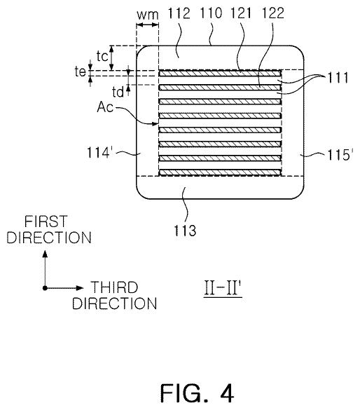

FIG. 4 schematically illustrates a cross-sectional view of FIG. 1, taken along line II-II′.

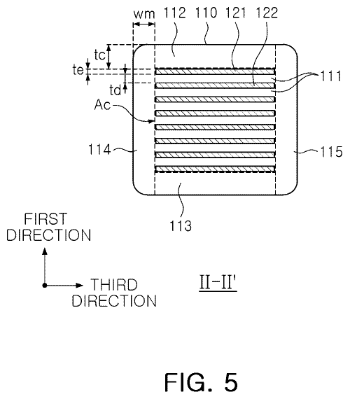

FIG. 5 schematically illustrates a cross-sectional view of FIG. 1, taken along line II-II′ according to another embodiment of the present disclosure.

Hereinafter, a multilayer electronic component according to an example embodiment of the present disclosure will be described in detail with reference to FIGS. 1 to 5. However, a multilayer ceramic capacitor will be described as an example of a multilayer electronic component, but the example embodiment may also be applied to various electronic products using a dielectric composition, such as an inductor, a piezoelectric element, a varistor, a thermistor, or the like.

A multilayer electronic component 100 according to an embodiment of the present disclosure may include a body 110 including a capacitance forming portion (Ac) including a dielectric layer 111 and internal electrodes 121 and 122 alternately disposed with the dielectric layer 111 in a first direction, and cover portions 112 and 113 disposed on both end surfaces of the capacitance forming portion (Ac) in the first direction; and external electrodes 131 and 132 disposed on the body 110, wherein the cover portions 112 and 113 may include titanium (Ti), gallium (Ga) and magnesium (Mg), wherein when the number of moles of gallium (Ga) relative to 100 moles of titanium (Ti) of the cover portions 112 and 113 is CG and the number of moles of magnesium (Mg) relative to 100 moles of titanium (Ti) of the cover portion is CM, 0.2≤CG/CM<1.00 may be satisfied.

The body 110 may have the dielectric layer 111 and the internal electrodes 121 and 122 alternately stacked.

More specifically, the body 110 may include a capacitance forming portion (Ac) disposed in the body 110 and including a first internal electrode 121 and a second internal electrode 122, alternately disposed to face each other with the dielectric layer 111 interposed therebetween, to form capacitance.

The body 110 is not limited to a particular shape, and may have a hexahedral shape or a shape similar to the hexahedral shape, as illustrated in the drawings. The body 110 may not have the shape of a hexahedron having perfectly straight lines because ceramic powder particles included in the body 110 are contracted in a process in which the body is sintered. However, the body 110 may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1,2,3, and 4 and opposing each other in a third direction.

A plurality of dielectric layers 111 forming the body 110 may be in a sintered state, and adjacent dielectric layers 111 may be integrated with each other, such that boundaries therebetween may not be readily apparent without a scanning electron microscope (SEM).

A raw material for forming the dielectric layer 111 is not particularly limited, as long as sufficient capacitance may be obtained therewith. In general, a perovskite (ABO₃)-based material may be used, and for example, a barium titanate-based material, a lead composite perovskite-based material, a strontium titanate-based material, or the like, may be used. The barium titanate-based material may include a BaTiO₃-based ceramic powder, and examples of the ceramic powder may include BaTiO₃, or (Ba₁₋ₓCaₓ)TiO₃ (0<x<1), Ba (Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), or the like, in which calcium (Ca), zirconium (Zr), or the like is partially dissolved in BaTiO₃, or the like.

In addition, the raw material for forming the dielectric layer 111 may include various ceramic additives, organic solvents, binders, dispersants, and the like, added to powder particles such as barium titanate (BaTiO₃) powder particles, or the like, according to an object of the present disclosure.

In addition, in the present disclosure, as an example of a more specific method for measuring a content of elements included in each component of the multilayer electronic component 100, the components may be analyzed using an energy dispersive X-ray spectroscopy (EDS) mode of a scanning electron microscope (SEM), an EDS mode of a transmission electron microscope (TEM), or an EDS mode of a scanning transmission electron microscope (STEM). First, a thinned analysis sample is prepared using a focused ion beam (FIB) device from a region of a cross-section of the sintered body, cover portion, or side margin portion, including a dielectric microstructure. A damaged layer on a surface of the thinned sample is removed using xenon (Xe) or argon (Ar) ion milling, and then each component to be measured is mapped from an image obtained using SEM-EDS, TEM-EDS, or STEM-EDS to conduct qualitative/quantitative analysis. In this case, the qualitative/quantitative analysis graph of each component may be represented by being converted into a mass percentage (wt %), atomic percentage (at %), or mole percentage (mol %) of each element. In this case, it may be represented by converting the number of moles of a specific component into the number of moles of another specific component.

As another method, a region including a dielectric microstructure may be selected by crushing chips, and then the selected region including the dielectric microstructure may be analyzed for components of the area including the dielectric microstructure using a device such as an inductively coupled plasma optical emission spectrometer (ICP-OES) or an inductively coupled plasma mass spectrometer (ICP-MS). Other methods and/or tools appreciated by one of ordinary skill in the art, even if not described in the present disclosure, may also be used.

Meanwhile, in order to distinguish the region from dielectric layers included in cover portions 112 and 113 and side margin portions 114 and 115, to be described later, the dielectric layer included in the capacitance forming portion (Ac) may be defined as a first dielectric layer, the dielectric layer included in the cover portions 112 and 113 may be defined as a second dielectric layer, and the dielectric layer included in the side margin portions 114 and 115 may be defined as a third dielectric layer. However, unless otherwise specified, the description of the dielectric layer 111 may correspond to the description of the first dielectric layer 111.

Since the first to third dielectric layers may be formed using a dielectric material such as barium titanate (BaTiO₃), the first to third dielectric layers may include a dielectric microstructure after sintering. The dielectric microstructure may include a plurality of dielectric grains, grain boundaries disposed between the adjacent dielectric grains, and n-centers disposed at points at which three or more of the grain boundaries contact each other, and may include a plurality of dielectric grains, a plurality of grain boundaries, and a plurality of n-centers, respectively.

Meanwhile, the dielectric layer 111 may include little or no gallium (Ga). Alternatively, when the number of moles of gallium (Ga) relative to 100 moles of titanium (Ti) of the dielectric layer 111 is DG, 0 mole≤DG<0.1 mole may be satisfied. However, an embodiment thereof is not particularly limited thereto, and the number of moles of gallium (Ga) relative to 100 moles of a main component of the dielectric layer 111 may be referred to as DG, and the number of moles of gallium (Ga) relative to 100 moles of barium (Ba) of the dielectric layer 111 may be referred to as DG.

Here, the fact that the dielectric layer 111 of the capacitance forming portion (Ac) does not include gallium (Ga) may mean that a state of a dielectric slurry or a dielectric green sheet does not include gallium (Ga) before sintering the dielectric layer 111, and may mean that the dielectric layer 111 located in a central region of the capacitance forming portion (Ac) does not include gallium (Ga).

That is, even if gallium (Ga) included in the cover portions 112 and 113 described below undergoes a sintering process such as high-temperature heat treatment, gallium (Ga) may not diffuse into a region of the dielectric layer 111 of the capacitance forming portion (Ac) adjacent to the cover portions 112 and 113 among the capacitance forming portions (Ac), which may mean that the dielectric layer 111 located in the central region of the capacitance forming portion (Ac) does not include gallium (Ga).

For example, based on a cross-section of the body 110 in first and second directions from a center of the body in a third direction, when a 10 μm×10 μm region located in a central portion of the body 110 in the first and second directions is observed in a SEM-EDS, TEM-EDS, or STEM-EDS mode, it may mean that no gallium (Ga) is detected or gallium (Ga) is detected in an amount of less than 0.1 at % relative to 100 at % of titanium (Ti).

A thickness “td” of the dielectric layer 111 does not need to be particularly limited.

In order to secure reliability of a multilayer electronic component 100 under a high-voltage environment, the thickness “td” of the dielectric layer may be 10.0 μm or less. In addition, in order to achieve miniaturization and high capacitance of the multilayer electronic component 100, the thickness “td” of the dielectric layer may be 3.0 μm or less. In order to more easily achieve ultra-miniaturization and high capacitance, the thickness “td” of the dielectric layer may be 1.0 μm or less, preferably 0.6 μm or less, and more preferably 0.4 μm or less.

In this case, the thickness “td” of the dielectric layer may be a concept including the thickness “td” of at least one of a plurality of dielectric layers 111, or may be a concept including the thickness “td” of each of all dielectric layers 111.

Here, the thickness “td” of the dielectric layer may mean the thickness “td” of the dielectric layer disposed between the first and second internal electrodes 121 and 122.

Meanwhile, the thickness “td” of the dielectric layer may mean a size of the dielectric layer 111 in a first direction.

In addition, the thickness “td” of the dielectric layer may mean an average thickness “td” of a single dielectric layer, or an average thickness “td” of a plurality of dielectric layers.

The average size of the dielectric layer 111 in the first direction may be measured by scanning images of cross-sections of the body 110 in the first and second directions with a scanning electron microscope (SEM) at a magnification of 10,000. More specifically, the average size of a single dielectric layer 111 in the first direction may mean an average value calculated by measuring a size of a single dielectric layer 111 in the second direction at 10 equally spaced points in the scanned image in the first direction. The 10 equally spaced points may be designated in the capacitance forming portion Ac. In addition, when such an average value is measured by extensively using measurements of average values to 10 dielectric layers 111, the average size of the dielectric layers 111 in the first direction may be further generalized.

The internal electrodes 121 and 122 may be alternately stacked with the dielectric layer 111.

The internal electrodes 121 and 122 may include a first internal electrode and a second internal electrode 122, and the first and second internal electrodes 121 and 122 may be alternately disposed to oppose each other with the dielectric layers 111, constituting the body 110, interposed therebetween, and may be exposed to the third and fourth surfaces 3 and 4 of the body 110, respectively.

More specifically, the first internal electrode 121 may be spaced apart from the fourth surface 4, and may be exposed through the third surface 3, and the second internal electrode 122 may be spaced apart from the third surface 3, and may be exposed through the fourth surface 4. A first external electrode 131 may be disposed on the third surface 3 of the body 110 to be connected to the first internal electrode 121, and a second external electrode 132 may be disposed on the fourth surface 4 of the body 110 to be connected to the second internal electrode 122.

That is, the first internal electrode 121 may not be connected to the second external electrode 132, but may be connected to the first external electrode 131, and the second internal electrode 122 may not be connected to the first external electrode 131, but may be connected to the second external electrode 132. In this case, the first and second internal electrodes 121 and 122 may be electrically separated from each other by the dielectric layer 111 interposed therebetween.

Meanwhile, the body 110 may be formed by alternately stacking a first ceramic green sheet on which a paste for a first internal electrode, to become the first internal electrode 121, is printed, and a second ceramic green sheet on which a paste for a second internal electrode, to become the second internal electrode 122, is printed, and then sintering the stacked ceramic green sheets.

A material for forming the internal electrodes 121 and 122 not particularly limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for the internal electrodes containing at least one of nickel (Ni), copper (Cu), palladium (Pd), silver (Ag), gold (Au), platinum (Pt), tin (Sn), tungsten (W), titanium (Ti), and alloys thereof, on the ceramic green sheets. As a printing method of the conductive paste for the internal electrodes, a screen-printing method, a gravure printing method, or the like may be used, but an embodiment of the present disclosure is not limited thereto.

Meanwhile, a thickness “the” of the internal electrodes 121 and 122 is not particularly limited.

To ensure the reliability of a multilayer electronic component 100 under a high-voltage environment, the thickness “the” of the internal electrode may be 3.0 μm or less. In addition, in order to achieve miniaturization and high capacitance of the multilayer electronic component 100, the thickness “the” of the internal electrode may be 1.0 μm or less. To more easily achieve miniaturization and high capacitance, the thickness “the” of the internal electrode may be 0.6 μm or less, and more preferably 0.4 μm or less.

In this case, the thickness “the” of the internal electrode may be a concept including a thickness “the” of at least one of a plurality of internal electrodes, or may be a concept including a thickness “the” of all internal electrodes.

Here, the thickness “the” of the internal electrode may mean a size of the internal electrodes 121 and 122 in a first direction.

In addition, the thickness “the” of the internal electrode may an average thickness “the” of one internal electrode, or may mean the average thickness “the” of a plurality of internal electrodes.

An average size of the internal electrodes 121 and 122 in the first direction may be measured by scanning images of a cross-section of the body 110 in the first and second directions with a scanning electron microscope (SEM) at a magnification of 10,000. More specifically, the average size of one internal electrode in the first direction may mean an average value calculated by measuring a size of one internal electrode in the second direction at 10 equally spaced points in the scanned image in the first direction. The 10 equally spaced points may be designated in the capacitance forming portion (Ac). In addition, when such an average value is measured by extensively using measurements of average values to 10 internal electrodes, the average size of the plurality of internal electrodes in the first direction may be further generalized.

Meanwhile, in an embodiment of the present disclosure, the thickness “td” of at least one of the plurality of dielectric layers and the thickness “the” of at least one of the plurality of internal electrodes may satisfy 2×te<td.

In other words, the thickness “td” of one dielectric layer may be greater than twice the thickness “the” of one internal electrode. Preferably, the average thickness “td” of the plurality of dielectric layers may be greater than twice the average thickness “the” of the plurality of internal electrodes.

In general, the main issue for high-voltage electronic components is reliability problems due to a decrease in breakdown voltage (BDV) in a high-voltage environment.

Accordingly, in order to prevent a decrease in the breakdown voltage under a high-voltage environment, the average thickness “td” of the dielectric layer may be made larger than twice the average thickness “the” of the internal electrodes, thereby increasing the thickness of the dielectric layer, which is a distance between the internal electrodes, and improving the breakdown voltage characteristics.

When the average thickness “td” of the dielectric layer is less than or equal to twice the average thickness “the” of the internal electrode, the average thickness of the dielectric layer, which is a distance between the internal electrodes, may be thin, causing a decrease in the breakdown voltage and a short circuit between the internal electrodes.

Meanwhile, the body 110 may include cover portions 112 and 113 disposed on both end surfaces of the capacitance forming portion (Ac) in the first direction.

Specifically, the cover portions 112 and 113 may include a first cover portion 112 disposed on one surface of the capacitance forming portion (Ac) in a first direction and a second cover portion 113 disposed on the other surface of the capacitance forming portion (Ac) in the first direction. More specifically, for example, the cover portions 112 and 113 may include an upper cover portion 112 disposed above the capacitance forming portion (Ac) in the first direction and a lower cover portion 113 disposed below the capacitance forming portion (Ac) in the first direction.

Unless otherwise specifically described in the present disclosure, the description of the cover portions 112 and 113 may be a description of the first cover portion 112 and the second cover portion 113, and may be a description of each of the first cover portion 112 and the second cover portion 113.

The first cover portion 112 and the second cover portion 113 may be formed by disposing or stacking a single second dielectric layer or two or more second dielectric layers on upper and lower surfaces of the capacitance forming portion (Ac) in the first direction, respectively, and may basically play a role in preventing damage to the internal electrodes 121 and 122 due to physical or chemical stress.

The first cover portion 112 and the second cover portion 113 may not include the internal electrodes 121 and 122, and may include the same dielectric material as the first dielectric layer 111 of the capacitance forming portion. That is, the first cover portion 112 and the second cover portion 113 may include a ceramic material, and may include, for example, a barium titanate (BaTiO₃)-based ceramic material.

Meanwhile, the thickness “tc” of the cover portions 112 and 113 does not need to be particularly limited, and hereinafter, the description of the thickness “tc” of the cover portions 112 and 113 may mean the thickness “tc” of each of the first cover portion 112 and the second cover portion 113.

However, to more easily achieve miniaturization and high capacitance of the multilayer electronic component, the thickness “tc” of the cover portion may be 100 μm or less or 50 μm or less, preferably 30 μm or less, and in the case of ultra-small products, more preferably 20 μm or less.

Here, the thickness “tc” of the cover portion may mean a size of the cover portions 112 and 113 in the first direction.

In addition, the thickness “tc” of the cover portion may mean an average thickness “tc” of each of the first and second cover portions 112 and 113, and may mean an average size of the first and second cover portions 112 and 113.

The average size of the cover portions 112 and 113 in the first direction may be measured by scanning images of cross-sections of the body 110 in the first and second directions with a scanning electron microscope (SEM) at a magnification of 10,000. More specifically, the average size of one cover portion in the first direction may mean an average value calculated by measuring the size in the first direction at 10 equally spaced points in the second direction in the scanned image of one cover portion.

In addition, the average size of the cover portion in the first direction measured by the above-described method may be substantially the same as the average size of the cover portion in the first direction, in the cross-sections of the body 110 in the first and third directions.

Meanwhile, the cover portions 112 and 113 may include titanium (Ti), gallium (Ga) and magnesium (Mg), and may further include barium (Ba).

In other words, the cover portions 112 and 113 may have a different composition from the dielectric layer 111 of the capacitance forming portion (Ac).

Gallium (Ga) is a low-temperature sintering agent. Gallium (Ga) may induce density of a dielectric microstructure before the grain growth of dielectric grains, thereby suppressing the formation of pores, before the grain growth of dielectric grains, preventing breakdown voltage (BDV) caused by an electric field concentration phenomenon and blocking a moisture penetration path, thereby improving reliability. Here, breakdown voltage (BDV) may mean breakdown voltage characteristics.

In this case, when the number of moles of gallium (Ga) relative to 100 moles of titanium (Ti) of the cover portions 112 and 113 is CG and the number of moles of magnesium (Mg) relative to 100 moles of titanium (Ti) of the cover portions 112 and 113 is CM, 0.2≤CG/CM<1.0 may be satisfied. However, an embodiment thereof is not particularly limited thereto, and the number of moles of gallium (Ga) relative to 100 moles of a main component of the cover portions 112 and 113 may be referred to as CG, or the number of moles of gallium (Ga) relative to 100 moles of barium (Ba) of the cover portions 112 and 113 may be referred to as CG. The number of moles of magnesium (Mg) relative to 100 moles of the main component of the cover portions 112 and 113 may be referred to as CM, or the number of moles of magnesium (Mg) relative to 100 moles of barium (Ba) of the cover portions 112 and 113 may be referred to as CM.

When the cover portions 112 and 113 satisfy 0.2≤CG/CM<1.0, the number of pores (ea) and porosity (%) of the cover portions 112 and 113 may be reduced, thereby improving moisture resistance reliability, and enhancing breakdown voltage (BDV) characteristics.

When the cover portions 112 and 113 satisfy CG/CM<0.2 or 1.0≤CG/CM, there is a concern that moisture resistance reliability may be reduced because pores are not sufficiently removed, and the breakdown voltage (BDV) characteristics may not be excellent.

Meanwhile, a method for measuring the number of pores (ea) or porosity (%) in the present disclosure is not particularly limited, but a cross-section of a region to be measured may be imaged using a scanning electron microscope (SEM), a transmission electron microscope (TEM), a scanning transmission electron microscope (STEM), or the like, and then the number of pores may be counted based on the captured image using a program that can observe pores, or may be measured by calculating a percentage of an area of pores compared to an area of the captured image.

In this case, the cover portions 112 and 113 may satisfy 0.3 mol≤CG≤1.0 mol.

When the cover portions 112 and 113 satisfy 0.3 mol≤CG≤1.0 mol, a sintering temperature may be lowered to further reduce the number of pores and the porosity, thereby further improving the moisture resistance reliability and further improving the breakdown voltage (BDV) characteristics.

When the cover portions 112 and 113 satisfy CG<0.3 mol, it is not easy to control the grain growth of the dielectric grains, so pores may not be sufficiently removed, which may result in a decrease in moisture resistance reliability and poor breakdown voltage (BDV) characteristics.

When the cover portions 112 and 113 satisfy 1.0 mol<CG, the dispersibility may be reduced due to the excessive addition of gallium (Ga), which may cause the formation of aggregates. As a result, sufficient sintering density may not be secured or the cover portion may not be sintered, and there is a concern that moisture resistance reliability may be reduced since the pores may not be sufficiently removed, and the breakdown voltage (BDV) characteristics may not be excellent.

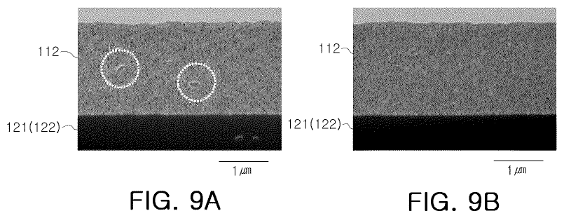

Referring to FIGS. 9A and 9B, FIG. 9A is an image of a cross-section of a cover portion before sintering of Comparative Example, taken using a transmission electron microscope (TEM), and FIG. 9B is an image of a cross-section of a cover portion before sintering of Example, taken using a transmission electron microscope (TEM). More specifically, FIG. 9A satisfies 1.0 mol<CG, and FIG. 9B satisfies 0.3 mol≤CG≤1.0 mol. As can be seen in FIG. 9A, aggregates (dotted circles) were formed due to the excessive addition of gallium (Ga) to the cover portion.

In addition, the cover portions 112 and 113 may satisfy 1.0 mol≤CM≤2.0 mol.

When the cover portions 112 and 113 satisfy 1.0 mol≤CM≤2.0 mol, the number of pores and the porosity may be further reduced, so that the moisture resistance reliability may be further improved, and the breakdown voltage (BDV) characteristics may be further improved.

When the cover portions 112 and 113 satisfy CM<1.0 mol, there is a concern that the moisture resistance reliability may be reduced because pores may not be sufficiently removed, and the breakdown voltage (BDV) characteristics may not be excellent.

When the cover portions 112 and 113 satisfy 2.0 mol<CM, the dispersibility may be reduced due to the excessive addition of magnesium (Mg), which may cause the formation of aggregates, and the moisture resistance reliability may be reduced because the pores may not be sufficiently removed. In addition, there is a concern that the internal electrodes 121 and 122 of the adjacent capacitance forming portion (Ac) may be oxidized, thereby deteriorating the electrical characteristics or reducing the breakdown voltage (BDV).

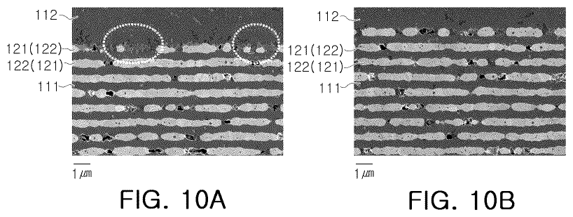

Referring to FIGS. 10A and 10B, FIG. 10A is an image of a cross-section of a cover portion and a capacitance forming portion of Comparative Example, taken using a transmission electron microscope (TEM), and FIG. 10B is an image of a cross-section of a cover portion and a capacitance forming portion of Example, taken using a transmission electron microscope (TEM). More specifically, FIG. 10A satisfies 2.0 mol<CM, and FIG. 10B satisfies 1.0 mol≤CG≤2.0 mol. As can be seen in FIG. 10A, it can be confirmed that the adjacent internal electrodes 121 and 122 are oxidized (dotted circle) due to the excessive addition of magnesium (Mg) to the cover portion.

As described above, the cover portions 112 and 113 may include a dielectric microstructure. In other words, the cover portions 112 and 113 may include a plurality of dielectric grains, grain boundaries disposed between the adjacent dielectric grains, and n-centers disposed at a point at which three or more of the grain boundaries contact each other.

In this case, an average size of a plurality of dielectric grains included in the cover portions 112 and 113 may be 150 nm or more and 250 nm or less.

In this case, an average size of a plurality of dielectric grains included in the cover portions 112 and 113 may be 150 nm or more and 250 nm or less. First, a 5 μm×5 μm area of the cross-section of the cover portions 112 and 113 is imaged using SEM, TEM, or STEM, and the plurality of dielectric grains observed in the captured image are distinguished using an image program (e.g., ‘Image Pro Plus’ or ‘Image J’). Thereafter, the size of each of the distinguished dielectric grains may be obtained using an image program, and the average size of the plurality of dielectric grains may also be obtained using an image program. Here, the size of dielectric grains may mean an average of a major diameter and a minor diameter passing through a center of the dielectric grain, and the average size of the plurality of dielectric grains may mean an average of the sizes of dielectric grains obtained by the above-described method, but is not particularly limited thereto. Other methods and/or tools appreciated by one of ordinary skill in the art, even if not described in the present disclosure, may also be used.

When the average size of the plurality of dielectric grains included in the cover portions 112 and 113 is 150 nm or more and 250 nm or less, the dielectric microstructure may be densified, thereby reducing the number of pores and enhancing mechanical properties, thereby enhancing impact resistance.

In this case, a size deviation of the plurality of dielectric grains included in the cover portions 112 and 113 may be 80 nm or less, more preferably 70 nm or less.

A lower limit value of the size deviation thereof is not particularly limited, and the smaller the size deviation, the better.

Here, the size deviation may mean a difference value (an absolute value) between an average size of a plurality of dielectric grains and a size of dielectric grains, and may mean that the size deviation of each of the dielectric grains is 80 nm or less.

When the size deviation of the plurality of dielectric grains included in the cover portions 112 and 113 is less than 80 nm, a dielectric microstructure may be densified to reduce the number of pores, and an electric field concentration phenomenon may be prevented to improve breakdown voltage (BDV) characteristics.

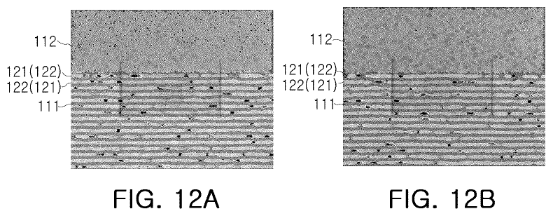

Referring to FIGS. 12A and 12B, FIG. 12A is an image of a cross-section of a cover portion of Comparative Example, taken using a transmission electron microscope (TEM) and the observed dielectric grains distinguished by a program, and FIG. 12B is an image of a cross-section of a cover portion of Example, taken using a transmission electron microscope (TEM) and the observed dielectric grains distinguished by a program. The average size of the plurality of dielectric grains observed in the Comparative Example of FIG. 12A was 154 nm and the size deviation was 114 nm or less, and the breakdown voltage characteristics were not excellent. On the other hand, the average size of the plurality of dielectric grains observed in the Example of FIG. 12B was 203 nm and the size deviation was 70 nm.

Meanwhile, at least one of grain boundaries and n-centers of the cover portions 112 and 113 may include a secondary phase including at least one of gallium (Ga) and magnesium (Mg) and titanium (Ti).

More specifically, the grain boundaries of the cover portions 112 and 113 may include a first secondary phase including at least one of gallium (Ga) and magnesium (Mg) and titanium (Ti), and/or the n-centers of the cover portions 112 and 113 may include a second secondary phase including at least one of gallium (Ga) and magnesium (Mg) and titanium (Ti).

In the present disclosure, the “secondary phase” may mean a particle or segregation having a different composition or crystal lattice from a perovskite (ABO₃)-based dielectric material.

More specifically, the secondary phase may have an atomic percentage (at %) of gallium (Ga) of 2 at % or more and 5 at % or less relative to 100 at % of titanium (Ti).

When the atomic percentage (at %) of gallium (Ga) relative to 100 at % of titanium (Ti) in the secondary phase is 2 at % or more and 5 at % or less, the number of pores and porosity of the cover portions 112 and 113 may be further reduced, thereby further improving moisture resistance reliability and further improving breakdown voltage (BDV) characteristics.

When the atomic percentage (at %) of gallium (Ga) relative to 100 at % of titanium (Ti) in the secondary phase is less than 2 at %, it is not easy to control the grain growth of dielectric grains, so pores may not be sufficiently removed, which may result in a decrease in moisture resistance reliability and poor breakdown voltage (BDV) characteristics.

When the atomic percentage (at %) of gallium (Ga) exceeds 5 at % relative to 100 at % of titanium (Ti) in the secondary phase, the dispersibility may be reduced due to excessive addition of gallium (Ga), which may cause aggregates to form. As a result, sufficient sintering density may not be secured or the cover portion may not be sintered, and pores may not be sufficiently removed, which may result in reduced moisture resistance reliability and poor breakdown voltage (BDV) characteristics.

The secondary phase may have an atomic percentage (at %) of magnesium (Mg) of 5 at % or more and 15 at % or less relative to 100 at % of titanium (Ti).

When the atomic percentage (at %) of magnesium (Mg) relative to 100 at % of titanium (Ti) in the secondary phase is 5 at % or more and 15 at % or less, the number of pores and porosity of the cover portions 112 and 113 may be further reduced, thereby further improving moisture resistance reliability and further improving breakdown voltage (BDV) characteristics.

When the atomic percentage (at %) of magnesium (Mg) relative to 100 at % of titanium (Ti) in the secondary phase is less than 5 at %, there is a concern that moisture resistance reliability may be reduced since pores may not be sufficiently removed, and the breakdown voltage (BDV) characteristics may not be excellent.

When the atomic percentage (at %) of magnesium (Mg) exceeds 15 at % relative to 100 at % of titanium (Ti) in the secondary phase, the dispersibility may be reduced due to the excessive addition of magnesium (Mg), which may cause the formation of aggregates. The moisture resistance reliability may be reduced because the pores are not sufficiently removed, and the breakdown voltage (BDV) characteristics may not be excellent. In addition, there is a concern that the internal electrodes 121 and 122 of the adjacent capacitance forming portion (Ac) may be oxidized, thereby deteriorating the electrical characteristics or reducing the breakdown voltage (BDV).

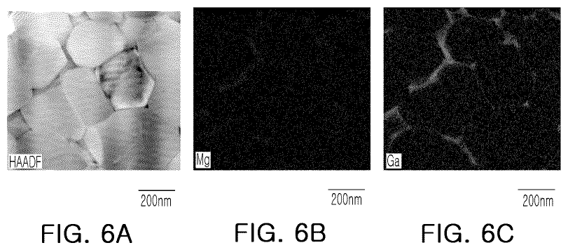

Referring to FIGS. 6A to 6C, which are embodiments of the present disclosure, FIG. 6A is an image of a cross-section of a cover portion, taken using a transmission electron microscope (TEM), FIG. 6B is an image of the same cross-section of the cover portion obtained by mapping magnesium (Mg) in a TEM-EDS mode, and FIG. 6C is an image of the same cross-section of the cover portion obtained by mapping gallium (Ga) in a TEM-EDS mode.

As can be seen in FIG. 6A, a secondary phase, not dielectric grains, is disposed at grain boundaries and n-centers, and more specifically, it can be seen that magnesium (Mg) is detected in the secondary phase in FIG. 6B, and it can be seen that gallium (Ga) is detected in the secondary phase in FIG. 6C. As a result of TEM-EDS point analysis on the secondary phase, 10.3 at % of magnesium (Mg) and 3.4 at % of gallium (Ga) were detected for 100 at % of titanium (Ti).

Meanwhile, the multilayer electronic component 100 may include side margin regions 114′ and 115′ which are end regions of the internal electrodes 121 and 122 in a third direction.

More specifically, the side margin regions 114′ and 115′ may include a first side margin region 114′ disposed between the internal electrodes 121 and 122 and the fifth surface 5 and a second side margin region 115′ disposed between the internal electrodes 121 and 122 and the sixth surface 6.

As illustrated, the side margin regions 114′ and 115′ may refer to regions between both ends of the first and second internal electrodes 121 and 122 in the third direction and a boundary surface of the body 110, based on a cross-section of the body 110 cut in the first and third directions.

The side margin regions 114′ and 115′ may refer to a ceramic green sheet region except for the internal electrodes 121 and 122, when a paste for internal electrodes is applied to a ceramic green sheet applied to the capacitance forming portion (Ac), except for a portion in which the side margin regions 114′ and 115′ are to be formed.

The side margin regions 114′ and 115′ may basically play a role in preventing damage to the internal electrodes 121 and 122 due to physical or chemical stress.

The first side margin region 114′ and the second side margin region 115′ may not include the internal electrodes 121 and 122, and may include the same material as the first dielectric layer 111, for example, may correspond to a portion of the first dielectric layer 111. That is, the first side margin region 114′ and the second side margin region 115′ may include a ceramic material, for example, a barium titanate (BaTiO₃)-based ceramic material.

Meanwhile, the multilayer electronic component 100 may include side margin portions 114 and 115 disposed on both end-surfaces of the body 110 in a third direction.

More specifically, the side margin portions 114 and 115 may include a first side margin portion 114 disposed on the fifth surface 5 of the body 110 and a second side margin portion 115 disposed on the sixth surface 6 of the body 110.

The side margin portions 114 and 115 may be formed by applying a conductive paste on a ceramic green sheet to form the internal electrodes 121 and 122, except for a portion in which the side margin portions 114 and 115 are to be formed, and, to suppress a step difference due to the internal electrodes 121 and 122, cutting the internal electrodes 121 and 122 to be exposed to the fifth and sixth surfaces 5 and 6 of the body 110, and then stacking or disposing a single third dielectric layer or two or more third dielectric layers in the third direction on both end-surfaces of the capacitance forming portion (Ac) in the third direction.

The side margin portions 114 and 115 may basically play a role in preventing damage to the internal electrodes 121 and 122 due to physical or chemical stress.

The first side margin portion 114 the second side margin portion 115 may not include the internal electrodes 121 and 122, and may include the same dielectric material as the dielectric layer 111. That is, the first side margin portion 114 and the second side margin portion 115 may include a ceramic material, and may include, for example, a barium titanate (BaTiO₃)-based ceramic material.

Meanwhile, a width “wm” of the side margin portions 114 and 115 does not need to be particularly limited, and hereinafter, the description of the width “wm” of the side margin portions 114 and 115 may mean the width “wm” of each of the first side margin portion 114 and the second side margin portion 115.

However, to more easily achieve miniaturization and high capacitance of the multilayer electronic component 100, the width “wm” of the side margin portion may be 50 μm or less, preferably 30 μm or less, and in the case of ultra-small products, more preferably 20 μm or less.

Here, the width “wm” of the side margin portion may mean a size of the margin portions 114 and 115 in a third direction.

In addition, the width “wm” of the side margin portions 114 and 115 may mean an average width “wm” of each of the first and second side margin portions 114 and 115, and may mean an average width “wm” of the first and second side margin portions 114 and 115.

An average size of the side margin portions 114 and 115 in the third direction may be measured by scanning images of cross-sections of the body 110 in the first and third directions with a scanning electron microscope (SEM) at a magnification of 10,000. More specifically, the average size of the side margin portions 114 and 115 in the third direction may refer to an average value calculated by measuring sizes in the third direction at 10 equally spaced points in the first direction in the scanned image of one side margin portion.

In an embodiment of the present disclosure, a structure in which the multilayer electronic component 100 has two external electrodes 131 and 132 is illustrated, but the number, shapes, or the like of the external electrodes 131 and 132 may be changed, depending on a shape of the internal electrodes 121 and 122, or other purposes.

The external electrodes 131 and 132 may be disposed on the body 110 and connected to the internal electrodes 121 and 122.

More specifically, the external electrodes 131 and 132 may include first and second external electrodes 131 and 132 respectively disposed on the third and fourth surfaces 3 and 4 of the body 110, and respectively connected to the first and second internal electrodes 121 and 122. That is, the first external electrode 131 may be disposed on the third surface 3 of the body and connected to the first internal electrode 121, and the second external electrode 132 may be disposed on the fourth surface 4 of the body and connected to the second internal electrode 122.

Additionally, the external electrodes 131 and 132 may be disposed to extend onto portions of the first and second surfaces 1 and 2 of the body 110, or may be disposed to extend onto portions of the fifth and sixth surfaces 5 and 6 of the body 110. That is, the first external electrode 131 may be disposed on the third surface 3 of the body 110 and portions of the first, second, fifth, and sixth surfaces 1, 2, 5, and 6 of the body 110, and the second external electrode 132 may be disposed on the fourth surface 4 of the body 110 and portions of the first, second, fifth, and sixth surfaces 1, 2, 5, and 6 of the body 110.

The external electrodes 131 and 132 may be formed of any material as long as they have electrical conductivity, such as metal, or the like, and a specific material may be determined in consideration of electrical characteristics, structural stability, or the like, and may further have a multilayer structure.

For example, the external electrodes 131 and 132 may include an electrode layer disposed on the body 110, and a plating layer disposed on the electrode layer. In this case, the electrode layer may include a first electrode layer disposed on the body and a second electrode layer disposed on the first electrode layer, and the plating layer may include a first plating layer disposed on the electrode layer and a second plating layer disposed on the first plating layer, but an embodiment thereof is not particularly limited thereto. The contents of the electrode layer and the plating layer will be described in more detail below.

The electrode layers 131a, 132a, 131b, and 132b may be formed by transferring a sheet including a conductive metal onto the body 110. Alternatively, they may be formed by applying a conductive paste for an external electrode including a conductive metal to the body 110 and then sintering the same, or they may be formed by dipping the body 110 into a conductive paste for an external electrode including a conductive metal, but an embodiment thereof is not particularly limited thereto.

As a more specific example of the electrode layers 131a, 132a, 131b, and 132b, the electrode layers 131a, 132a, 131b, and 132b may have a two-layer structure including first electrode layers 131a and 132a and second electrode layers 131b and 132b.

More specifically, the external electrodes 131 and 132 may include first electrode layers 131a and 132a including a first conductive metal and a glass, and second electrode layers 131b and 132b disposed on the first electrode layers 131a and 132a and including a second conductive metal and a resin.

A material having excellent electrical conductivity may be used as a conductive metal included in the electrode layers 131a, 132a, 131b, and 132b, and for example, may include at least one selected from the group consisting of nickel (Ni), copper (Cu), palladium (Pd), silver (Ag), gold (Au), platinum (Pt), tin (Sn), tungsten (W), titanium (Ti), and alloys thereof, but an embodiment thereof is not particularly limited thereto.

Here, the conductive metal included in the first electrode layers 131a and 132a may be referred to as a first conductive metal, and the conductive metal included in the second electrode layers 131b and 132b may be referred to as a second conductive metal. In this case, the first conductive metal and the second conductive metal may be the same or different from each other, and when a plurality of conductive metals are included, only a portion of the first conductive metal and the second conductive metal may include the same conductive metal, but this is not particularly limited thereto.

The glass included in the first electrode layers 131a and 132a may serve to improve bonding properties with the body 110, and the resin included in the second electrode layers 131b and 132b may play a role of improving bending strength.

The first conductive metal included in the first electrode layers 131a and 132a may serve to be electrically connected to the internal electrodes 121 and 122.

The first conductive metal included in the first electrode layers 131a and 132a is not particularly limited as long as it is a material that can be electrically connected with the internal electrodes 121 and 122, and for example, may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layers 131b and 132b may serve to be electrically connected to the first electrode layers 131a and 132a.

The second conductive metal included in the second electrode layers 131b and 132b is not particularly limited as long as it is a material that can be electrically connected to the first electrode layers 131a and 132a, and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layers 131b and 132b may include at least one of spherical particles and flake-shaped particles. That is, the second conductive metal may be composed of only flake-shaped particles, or may be composed of only spherical particles, or may be a mixed form of flake-shaped particles and spherical particles. Here, the spherical particles may also include a form other than a perfect spherical shape, and for example, may include a form in which a length ratio (major axis/minor axis) of a major axis to a minor axis is 1.45 or less. The flake-shaped particle refers to a particle having a flat and elongated shape, and is not particularly limited, but for example, the length ratio (major axis/minor axis) of the major axis to the minor axis may be 1.95 or more. The lengths of the major and minor axes of the spherical particles and flake-shaped particles may be measured from images obtained by scanning the cross-sections of the multilayer electronic component in the first and second directions, cut from the central portion in the third direction using a scanning electron microscope (SEM).

The resin included in the second electrode layers 131b and 132b may secure bonding properties and perform a role of shock absorption, and is not particularly limited as long as it can be mixed with second conductive metal particles to form a paste, and may include, for example, an epoxy-based resin.

In addition, the second electrode layers 131b and 132b may include an intermetallic compound.

The second electrode layers 131b and 132b may include an intermetallic compound, so that electric connectivity with the first electrode layers 131a and 132a may be further improved. The intermetallic compound may play a role of improving the electrical connectivity by connecting a plurality of second conductive metal particles, and may play a role of surrounding a plurality of second conductive metal particles and connecting the plurality of second conductive metal particles to each other.

In this case, the intermetallic compound may include a metal having a melting point lower than a curing temperature of a resin. That is, since the intermetallic compound includes a metal having a melting point lower than the curing temperature of the resin, the metal having a melting point lower than the curing temperature of the resin melts during a drying and curing process, forms an intermetallic compound with a portion of the metal particles, and surrounds the metal particles. In this case, the intermetallic compound may preferably include a low melting point metal of 300° C. or lower.

For example, the intermetallic compound may include Sn having a melting point of 213 to 220° C. During the drying and curing process, Sn melts, and the melted Sn wets high-melting-point metal particles such as Ag, Ni, or Cu by capillary action, and reacts with a portion of the Ag, Ni, or Cu metal particles to form intermetallic compounds such as Ag₃Sn, Ni₃Sn₄, Cu₆Sn₅, Cu₃Sn, or the like. Ag, Ni, or Cu that does not participate in the reaction remains in the form of metal particles.

Therefore, the plurality of second conductive metal particles may include one or more of Ag, Ni and Cu, and the intermetallic compound may include one or more of Ag₃Sn, Ni₃Sn₄, Cu₆Sn₅, and Cu₃Sn.

The plating layers 131c and 132c may serve to improve mounting characteristics.

A type of the plating layers 131c and 132c is not particularly limited, and for example, the plating layers 131c and 132c may include at least one of nickel (Ni), tin (Sn), silver (Ag), palladium (Pd), and alloys thereof.

The plating layers 131c and 132c may be single layers or may be a plurality of layers.

More specifically, for example, the plating layer may be a nickel (Ni) plating layer or a tin (Sn) plating layer, and may have a form in which a nickel (Ni) plating layer and a tin (Sn) plating layer are sequentially formed on the electrode layer, or may have a form in which a tin (Sn) plating layer, a nickel (Ni) plating layer, and a tin (Sn) plating layer are sequentially formed. In addition, the plating layers 131c and 132c may include a plurality of nickel (Ni) plating layers and/or a plurality of tin (Sn) plating layers.

A size of the multilayer electronic component 100 does not need to be particularly limited.

However, to achieve both miniaturization and high capacitance, thicknesses of the dielectric layer and internal electrodes should be thinned to increase the number of stacks. Therefore, an effect according to the present disclosure may become more noticeable in a multilayer electronic component 100 having a size of 3216 (length×width: 3.2 mm×1.6 mm, and length and width satisfy an error of within +5%) or less.

Hereinafter, the present disclosure will be described in more detail through examples, but these are intended to help a specific understanding of the disclosure and the scope of the present disclosure is not limited by the examples.

### Test Example

Comparative Example 1 illustrates a chip manufactured with a cover portion of CG/CM<0.2, and Example 1 illustrates a chip manufactured in the same manner as Comparative Example 1 except that the cover portion is 0.2≤CG/CM<1.00.

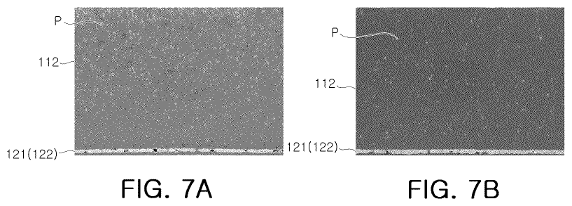

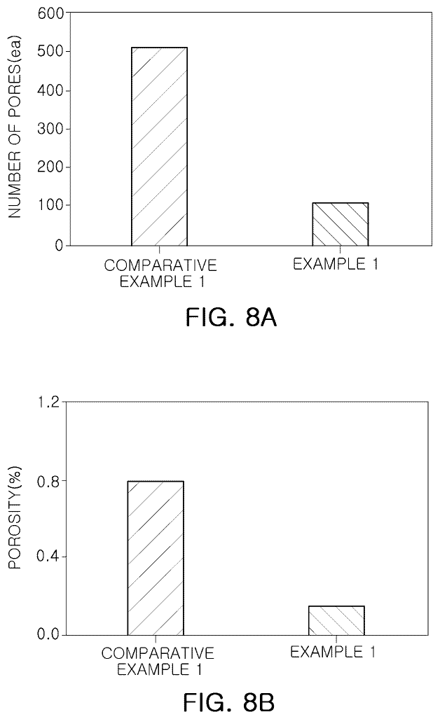

More specifically, referring to FIGS. 7A to 8B, FIG. 7A is an image of pores observed in a cross-section of a cover portion of Comparative Example 1, and FIG. 7B is an image of pores observed in a cross-section of a cover portion of Example 1. FIG. 8A is a graph illustrating the number of pores per unit area (ea/547 μm²) observed in cross-sections of cover portions of Comparative Example 1 and Example 1, and FIG. 8B is a graph illustrating porosity (%) in cross-sections of cover portions of Comparative Example 1 and Example 1.

In Comparative Example 1, the number of pores per unit area (ea/547 μm²) is about 500, while in Example 1, the number of pores per unit area (ea/547 μm²) is about 100, and in Comparative Example 1, the porosity (%) is about 0.8%, while in Example 1, the porosity (%) is about 0.15%. Therefore, when the cover portion satisfies 0.2≤CG/CM<1.00, it can be confirmed that the number of pores and the porosity may be reduced, and it can be predicted that the moisture resistance reliability may be improved.

Comparative Example 2 illustrates a chip manufactured with a cover portion having CG/CM<0.2, and Example 2 illustrates a chip manufactured in the same manner as Comparative Example 2 except that the cover portion has 0.2≤CG/CM<1.00.

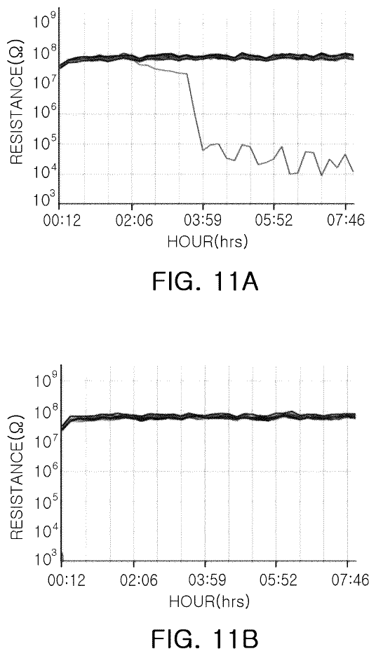

Referring to FIGS. 11A and 11B, FIG. 11A is a moisture resistance reliability evaluation graph of Comparative Example 2, and FIG. 11B is a moisture resistance reliability evaluation graph of Example 2.

Moisture resistance reliability evaluation was conducted by manufacturing 20 channels with 20 chips mounted on each channel, and applying a voltage of 6.3 V for 8 hours in an environment with a temperature of 85° C. and a relative humidity of 85%. In this case, the resistance of the channel (chip) fell below 10⁵Ω, it was evaluated as defective.

In the case of Comparative Example 2, a defect occurred in one channel (chip), but in the case of Example 2, no defect occurred in all channels (chips). Therefore, it can be seen that the moisture resistance reliability is improved when the cover portion satisfies 0.2≤CG/CM<1.00.

Table 1 below describes the number of pores per unit area (ea/547 μm²), porosity (%), whether or not aggregates are formed, breakdown voltage (BDV), and moisture resistance reliability of Comparative Examples 3 to 6 and Examples 3 to 6, which were manufactured with different CG/CMs of the cover portions. Comparative Examples 3 to 6 and Examples 3 to 6 were manufactured in the same manner except that the CG/CMs of the cover portions were different.

More specifically, Comparative Example 3 has CG-0 mol, CM=1.5 mol and CG/CM=0, Comparative Example 4 has CG=1.2 mol, CM=0.3 mol and CG/CM=4, Comparative Example 5 has CG-0.1 mol, CM=2.5 mol and CG/CM=0.04, and Comparative Example 6 has CG=1.0 mol, CM=1.0 mol and CG/CM=1. Example 3 has CG-0.3 mol, CM=1.5 mol and CG/CM=0.2, Example 4 has CG=0.6 mol, CM=1.5 mol and CG/CM=0.4, Example 5 has CG=1.0 mol, CM=1.5 mol and about CG/CM=0.7, and Example 6 has CG-0.9 mol, CM=1.0 mol and CG/CM=0.9.

The number of pores (ea/547 μm²) is the number of pores per unit area observed in a cross-section of the cover portion, and porosity (%) is an area of pores expressed as a percentage based on the observed cross-section of the cover portion.

When aggregates were observed in a sheet of the cover portion before sintering, a case in which aggregates were observed was marked as O, and a case in which no aggregates were observed was marked as X.

For the breakdown voltage (BDV) evaluation (Keithley equipment), based on a voltage value (V) at which insulation breakage occurs and a process capability index (Cpk), when the breakdown voltage is 50 V or higher and the Cpk is 1.5 or higher, it was evaluated to be excellent and described as O, when the breakdown voltage is 40 V or higher and less than 50 V and Cpk is 1.5 or higher, it was evaluated to be normal and described as A, and when the breakdown voltage is less than 40 V and Cpk is 1.5 or less, it was evaluated to be defective and described as X.

For the moisture-resistance reliability evaluation, after manufacturing 20 channels with 20 chips mounted on each channel, when a voltage of 6.3 V was applied for 8 hours in an environment of a temperature of 85° C. and a relative humidity of 85%, when the resistance of even one channel (chip) felt below 105Ω, it was evaluated to be defective and described as X, and when the resistance of all channels (chips) did not fall below 105Ω, it was evaluated to be excellent and described as O.

TABLE 1

| | | Number of | | | | Moisture |
|---|---|---|---|---|---|---|
| | | pores(ea/ | | | BDV | resistance |
| | CG/CM | 547 μm²) | Porosity(%) | Aggregates | evaluation | reliability |
| Comparative | 0 | 512 | 0.79 | X | X | X |
| Example 3 | | | | | | |
| Comparative | 4 | 225 | 0.14 | ◯ | X | X |
| Example 4 | | | | | | |
| Comparative | 0.04 | 301 | 0.16 | X | Δ | X |
| Example 5 | | | | | | |
| Comparative | 1 | 189 | 0.24 | ◯ | Δ | X |
| Example 6 | | | | | | |
| Example 3 | 0.2 | 121 | 0.15 | X | ◯ | ◯ |
| Example 4 | 0.4 | 118 | 0.16 | X | ◯ | ◯ |
| Example 5 | 0.7 | 109 | 0.14 | X | ◯ | ◯ |
| Example 6 | 0.9 | 112 | 0.15 | X | ◯ | ◯ |

Comparative Example 3 had the largest number of pores and the highest porosity, and no aggregates occurred, but the breakdown voltage (BDV) and moisture resistance reliability were poor. Comparative Example 4 had a low porosity but a large number of pores, aggregates occurred, and the breakdown voltage (BDV) and moisture resistance reliability were poor. Comparative Example 5 had a low porosity but a large number of pores and no aggregates occurred, but the breakdown voltage (BDV) was normal and the moisture resistance reliability was poor. Comparative Example 6 had a relatively large number of pores and a relatively high porosity, aggregates occurred, the breakdown voltage (BDV) was average, and the moisture resistance reliability was poor.

On the other hand, in Examples 3 to 6, no aggregates occurred, the number of pores and porosity were small or low, and the breakdown voltage (BDV) and moisture resistance reliability were excellent.

Accordingly, it can be seen that when the cover portion is 0.2≤CG/CM<1.00, the number of pores is small, the porosity is low, no aggregates occur, and the breakdown voltage (BDV) and moisture resistance reliability are excellent.

As set forth above, according to one of the many effects of the present disclosure, by improving density of a cover portion to suppress the formation of pores, moisture resistance reliability of a multilayer electronic component is improved.

According to one of many effects of the present disclosure, breakdown voltage characteristics of a multilayer electronic component is improved.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including a capacitance forming portion including a dielectric layer and an internal electrode alternately disposed with the dielectric layer in a first direction, and a cover portion disposed on both end surfaces of the capacitance forming portion in the first direction; and
an external electrode disposed on the body,
wherein the cover portion includes titanium (Ti), gallium (Ga), and magnesium (Mg), and when a number of moles of gallium (Ga) relative to 100 moles of titanium (Ti) of the cover portion is CG and a number of moles of magnesium (Mg) relative to 100 moles of titanium (Ti) of the cover portion is CM,
0.2≤CG/CM<1.0 is satisfied.

2. The multilayer electronic component of claim 1, wherein the CG satisfies 0.3 mol≤CG≤1.0 mol.

3. The multilayer electronic component of claim 1, wherein the CM satisfies 1.0 mol≤CM≤2.0 mol.

4. The multilayer electronic component of claim 1, wherein the cover portion has a composition different from a composition of the dielectric layer.

5. The multilayer electronic component of claim 1, wherein the dielectric layer comprises titanium (Ti), and
when the number of moles of gallium (Ga) relative to 100 moles of titanium (Ti) of the dielectric layer is DG,
DG<CG is satisfied.

6. The multilayer electronic component of claim 5, wherein the DG satisfies 0 mol≤DG<0.1 mol.

7. The multilayer electronic component of claim 1, wherein the cover portion comprises a plurality of dielectric grains, and
an average size of the plurality of dielectric grains included in the cover portion is 150 nm or more and 250 nm or less.

8. The multilayer electronic component of claim 1, wherein the cover portion comprises a plurality of dielectric grains, and
a size deviation of the plurality of dielectric grains included in the cover portion is 80 nm or less.

9. The multilayer electronic component of claim 1, wherein the cover portion comprises a plurality of dielectric grains, grain boundaries disposed between adjacent dielectric grains among the plurality of dielectric grains, and n-centers disposed at a point at which three or more of the grain boundaries contact each other, and
at least one of the grain boundaries, at least one of the n-centers, or at least one of the grain boundaries and at least one of the n-centers include a secondary phase including at least one selected from gallium (Ga), magnesium (Mg), and titanium (Ti).

10. The multilayer electronic component of claim 9, wherein the secondary phase has an atomic percentage of gallium (Ga) of 2 at % or more and 5 at % or less relative to 100 at % of titanium (Ti).

11. The multilayer electronic component of claim 9, wherein the secondary phase has an atomic percentage of magnesium (Mg) of 5 at % or more and 15 at % or less relative to 100 at % of titanium (Ti).

12. The multilayer electronic component of claim 9, wherein at least one of the grain boundaries includes the secondary phase.

13. The multilayer electronic component of claim 9, wherein at least one of the n-centers includes the secondary phase.

14. The multilayer electronic component of claim 9, wherein at least one of the grain boundaries and at least one of the n-centers include the secondary phase.
